(19) United States
(12) Patent Application Publication
(10) Pub. No.: US 2018/0093291 A1
(43) Pub. Date: Apr. 5, 2018

(54) CONTROL OF ULTRASONIC NEBULIZERS IN A HUMIDIFIER

(71) Applicant: STULZ Air Technology Systems, Inc., Frederick, MD (US)

(72) Inventor: Richard Longley Benjamin, Frederick, MD (US)

(73) Assignee: STULZ Air Technology Systems, Inc., Frederick, MD (US)

(21) Appl. No.: 15/723,632

(22) Filed: Oct. 3, 2017

Related U.S. Application Data
(60) Provisional application No. 62/403,829, filed on Oct. 4, 2016.

(51) Int. Cl. B05B 17/06; B05B 9/00; G05B 15/02

(52) U.S. Cl. CPC B05B 17/0607; G05B 15/02; B05B 9/002

(57) ABSTRACT

A humidifier includes a water supply and a nebulizer bank having a plurality of ultrasonic nebulizers, where each of the plurality of ultrasonic nebulizers is in fluid communication with the water supply and is structurally configured for breaking up water in liquid form into aerosol droplets for humidifying a volume. The humidifier may further include a controller in communication with each of the plurality of ultrasonic nebulizers to selectively activate each of the plurality of ultrasonic nebulizers independently from one another, where the controller is configured to stage activation of one or more of the plurality of ultrasonic nebulizers while accounting for at least one of: (i) a time from startup to a production of an aerosol droplet for each ultrasonic nebulizer; (ii) a threshold power consumption for the humidifier; (iii) a temperature of a component of the humidifier; and (iv) a predetermined humidity of the volume.

### BACKGROUND

In general, ultrasonic nebulizers use ultrasonic power to break up liquids into small aerosol droplets. An example of an ultrasonic nebulizer, e.g., an ultrasonic wave nebulizer, can be found in U.S. Pat. No. 3,901,443, which is incorporated herein by reference in its entirety.

Ultrasonic nebulizers can be used in humidifiers (i.e., ultrasonic humidifiers) to spray out water aerosols, e.g., to moisten dry air in a space. An ultrasonic humidifier may include one or more ultrasonic nebulizers mounted in the same tank. The number has traditionally been up to about 64 ultrasonic nebulizers in the tank, where each can draw about 30 watts or more.

Traditional methods of controlling a plurality of ultrasonic nebulizers in an ultrasonic humidifier can include switching power on and off to all nebulizers simultaneously using a pulse width modulation (PWM) scheme on the applied power. Additionally, temperature control of the nebulizers may be accomplished by attaching one or more discrete temperature switches or sensors to the tank of the ultrasonic humidifier. Additionally, capacity assistance may be accomplished by installing multiple ultrasonic humidifiers, where additional humidifiers are turned on as the need for more humidification is called for in a space.

Because of the relatively large number of ultrasonic nebulizers that may be included in the tank of an ultrasonic humidifier, simultaneously turning on and off all of the ultrasonic nebulizers in the tank may produce large steps in the current demands of the power supply, stressing the power supply, and generating large current pulses, e.g., on the order of 10 microseconds or less.

There remains a need for devices, systems, and methods to provide improved control of ultrasonic nebulizers in a humidifier, e.g., individual control of each ultrasonic nebulizer in a humidifier to effectively control the power management of the entire humidifier.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 illustrates a block diagram of an ultrasonic nebulizer, in accordance with a representative embodiment.

FIG. 2 illustrates a block diagram of a control system for an ultrasonic nebulizer, in accordance with a representative embodiment.

FIG. 3 illustrates a block diagram of a control system for an ultrasonic humidifier, in accordance with a representative embodiment.

FIG. 4 illustrates a timing diagram, in accordance with a representative embodiment.

FIG. 5 illustrates a pulse width modulation (PWM) scheme for ultrasonic nebulizers, in accordance with a representative embodiment.

FIG. 6 illustrates a transition of output for ultrasonic nebulizers, in accordance with a representative embodiment.

FIG. 7 illustrates current demand on power for ultrasonic nebulizers, in accordance with a representative embodiment.

FIG. 8 illustrates a flow chart of a method for determining the percent output for ultrasonic nebulizers, in accordance with a representative embodiment.

FIG. 9 illustrates a flow chart of a method for managing packets for ultrasonic nebulizers, in accordance with a representative embodiment.

FIG. 10 illustrates a flow chart of a method for temperature checks for a humidifier, in accordance with a representative embodiment.

FIG. 11 illustrates a flow chart of a method for determining a PWM duty cycle for ultrasonic nebulizers, in accordance with a representative embodiment.

FIG. 12 illustrates a flow chart of a method for PWM timing for ultrasonic nebulizers, in accordance with a representative embodiment.

FIG. 13 illustrates a system for humidification, in accordance with a representative embodiment.

FIG. 14 illustrates a flow chart of a method for humidification, in accordance with a representative embodiment.

### DETAILED DESCRIPTION

The various methods, systems, apparatus, and devices described herein generally provide for the control of ultrasonic nebulizers in a humidifier or humidifier systems.

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

All documents mentioned herein are hereby incorporated by reference in their entirety. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus and device may be used interchangeably in this text.

In general, the devices, systems, and methods described herein may provide control of nebulizers in a humidifier, e.g., the individual control of ultrasonic nebulizers in an ultrasonic humidifier. Although the devices, systems, and methods described herein may emphasize the control of ultrasonic nebulizers, the control of other types of nebulizers may also or instead be made possible through the devices, systems, and methods described herein including nebulizers using oxygen, compressed air, and the like. Similarly, although the devices, systems, and methods described herein may emphasize the control of nebulizers in a humidifier, the control of other components (e.g., besides nebulizers) and/or other devices (e.g., besides humidifiers) may also or instead be made possible through the devices, systems, and methods described herein.

An implementation includes the controlling and monitoring of ultrasonic nebulizers in an ultrasonic humidifier in a manner that allows precise control of the output of the ultrasonic humidifier. This may be accomplished through the individual control of each ultrasonic nebulizer included in an ultrasonic humidifier, as well as the monitoring of the status of each ultrasonic nebulizer in an ultrasonic humidifier.

Implementations may thus include the network control of one or more ultrasonic nebulizers in an ultrasonic humidifier, e.g., allowing for the control and monitoring of each ultrasonic nebulizer independently from other ultrasonic nebulizers in a single ultrasonic humidifier. Implementations may include a controller to manage the overall operations of the humidifier. Implementations may eliminate a need for a power switch of the supply voltage and may thus prevent or avoid the resulting surge of current when turning the humidifier output on and off.

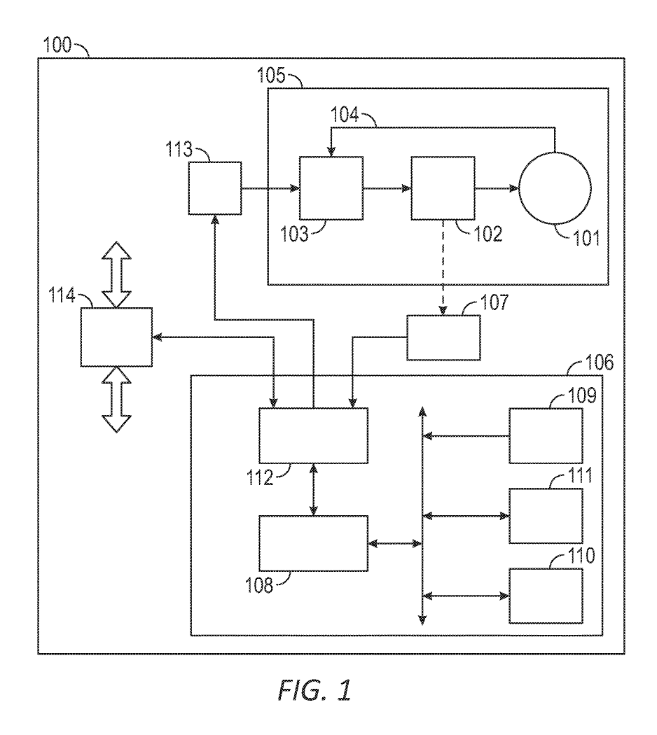

FIG. 1 illustrates a block diagram of an ultrasonic nebulizer, in accordance with a representative embodiment. The block diagram of this figure may represent a nebulizer that is retrofitted with components to achieve individual nebulizer control.

Implementations may thus add localized control to a self-tuning oscillator circuit of an existing nebulizer such as those described in U.S. Pat. No. 3,901,443, which is incorporated herein by reference in its entirety. The nebulizer printed circuit may be mounted to the tank of a humidifier, e.g., the tank is used as a heat sink for the power transistor in the oscillator circuit.

FIG. 1 shows an example of the nebulizer 100 including an existing circuit 105 (in an existing nebulizer) that includes an oscillator circuit 103 with a power transistor 102 driving a piezoelectric transducer 101. In an implementation, variations in the electrical characteristics of the piezoelectric transducer 101 control the oscillator circuit 103 via a feedback mechanism 104 (e.g., for self-tuning).

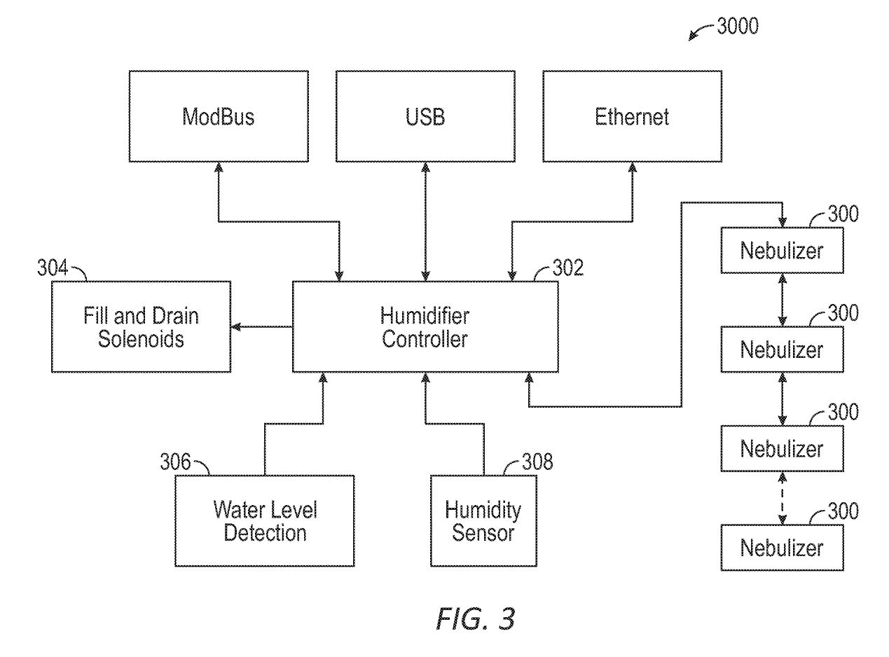

The nebulizer 100 may include a temperature sensor 107, a controller 106, a switch 113 (e.g., on/off control), and a network interface 114, where these components may represent additions to an existing nebulizer 100 to provide localized control. The network interface 114 may be used to convey commands from a higher-level controller (see, e.g., FIG. 3) and to retrieve status from the nebulizer 100. A microcontroller 106 may be embedded on the circuit board to manage the network, turn the oscillator circuit on and off via the switch 113, e.g., using a pulse width modulation (PWM) scheme, and to monitor the temperature of the nebulizer heat sink via a sensor 117 to protect the nebulizer 100 from overheating due to such mechanisms such as the lack of water that can cause failure of the device.

The microcontroller 106 may include a central processing unit 108 (CPU) that executes instructions stored in memory 109, e.g., permanent program memory. Temporary information may be stored in a volatile memory 110 while key parameters like the network address of the nebulizer 100 may be stored in a flash memory 111. The flash memory 111 may retain its contents when power is removed. The microcontroller 106 may have analog inputs and digital points that can be either inputs or outputs 112 (e.g., a digital and analog input/output). An analog input may be used to measure the temperature of the heat sink for the power transistor 102. The heat sink may be thermally bonded to the tank and the power transistor, giving a sufficient indication of the operating conditions for protecting the transducer and transistor.

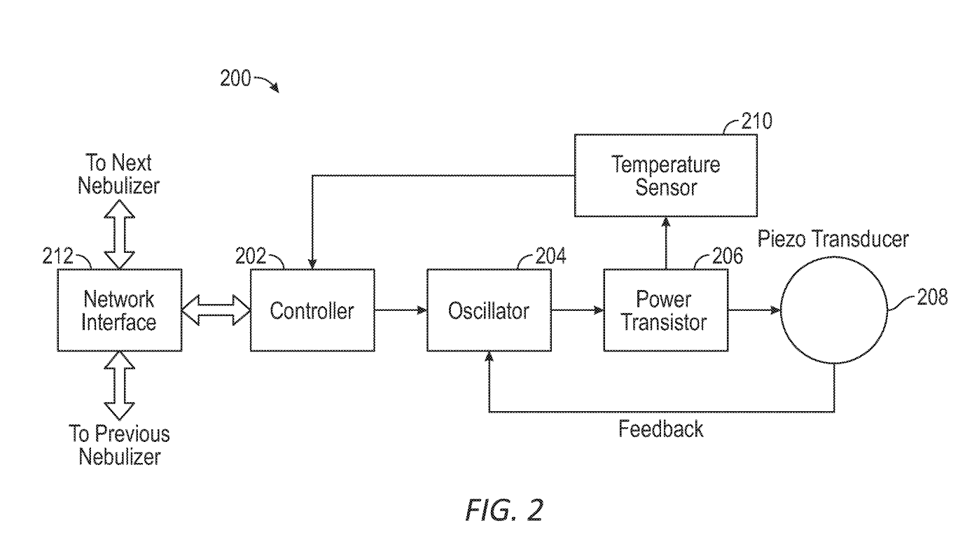

FIG. 2 illustrates a block diagram of a control system for an ultrasonic nebulizer, in accordance with a representative embodiment. This figure may represent a simplified version of that shown in FIG. 1 above. Specifically, the system 200 shown in the figure may include a controller 202, an oscillator 204, a power transistor 206, a transducer 208 (e.g., a piezo transducer), a sensor 210 (e.g., a temperature sensor), and a network interface 212 for connecting one or more of the participants in the system 200 in a communicating relationship.

The oscillator 204 and its components, as well as the power transistor 206 and the transducer 208, may form a closed loop oscillating circuit, e.g., one that operates in the vicinity of about 1.6 megahertz, thereby causing water molecules to atomize above the transducer 208. The oscillating circuit may be started and stopped by the controller 202 based on information conveyed to the controller 202 over a communications network through the network interface 212 and one or more sensors 210, e.g., a sensor 210 monitoring the temperature of the power transistor 206. The controller 202 and the network interface 212 may be a single integrated circuit or a combination of integrated circuits and other electrical components. Information received by the controller 202 over the network may include, but is not limited to, a PWM period and duty cycle, start or stop PWM operations, and the like. The controller 202 may convey status information to the network upon request, which may include, but is not limited to, the temperature, over and under temperature alarms, failure of the oscillator circuit to function properly, and the like.

FIG. 3 illustrates a block diagram of a control system for an ultrasonic humidifier, in accordance with a representative embodiment. By way of example, the figure shows the use of nebulizers in a humidifier, while also showing other components that may be used in constructing a humidifier.

As stated above, FIG. 3 may represent the use of nebulizers in a humidifier. Multiple nebulizers 300 may be networked in series to a humidifier controller 302, where the humidifier controller 302 determines the period and the duty cycle of each nebulizer 300 based on inputs to maintain a predetermined humidity or dew point, e.g., using internal sensors or information provided over an interface to a higher-level system. The humidifier controller 302 may maintain the water level in the tank of the humidifier through control of fill and drain solenoids 304 based on level switch inputs 306 (shown as “water level detection” in the figure, where the water level detection may include at least two levels—full and empty). Control of the output of the humidifier may be based on a humidity or dew point sensor 308 (and local set point) mounted in the humidifier or by commands over a higher-level network. In a stand-alone application, the controller 302 may energize a fan to circulate the air being moistened. Humidifiers mounted in duct work may instead use the HVAC system blower to dissipate moisture.

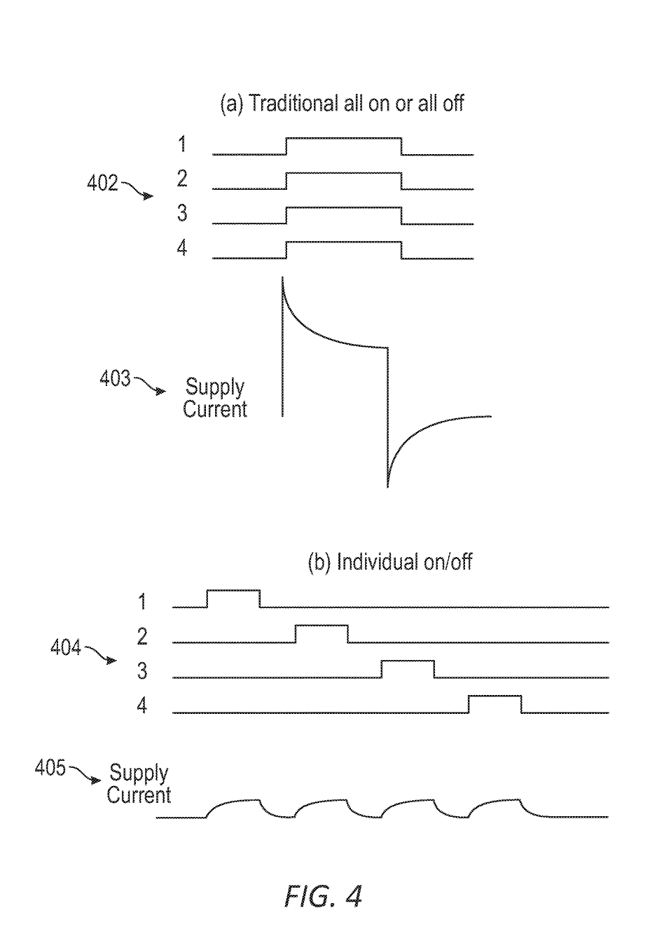

FIG. 4 illustrates a timing diagram, in accordance with a representative embodiment. The figure shows, by way of example, a prior art method of controlling nebulizers and the resulting current demand (i.e., labeled as “(a) Traditional all on or all off” in the figure) versus a method according to an implementation as described herein (i.e., labeled as “(b) Individual on/off” in the figure). FIG. 4 thus shows an example of the timing and current demand used in an existing ultrasonic humidifier with multiple nebulizers (i.e., the first graph 402), and the timing and current demand used in an ultrasonic humidifier with individual control of each nebulizer (i.e., the second graph 404).

In the existing ultrasonic humidifier, all nebulizers may be turned on and off simultaneously using a power switch to apply power to all nebulizers and then to remove that power. The period may be fixed and the duty cycle may be varied to achieve capacity control. The current demand 403 on the power supply is shown including the inrush of current when turning on and off the nebulizers as capacitors charge and discharge in the nebulizers. The current surges may be sources of conducted electromagnetic interference.

In an ultrasonic humidifier with individual control of each nebulizer, all nebulizers may have power applied at all times, resulting in a one-time power up inrush of current. The current demand 405 may rise as the oscillator starts without the inrush of current. By controlling the start of each nebulizer and the period and duty cycle of the PWM, the size of the current drawn from the power supply may be reduced from the original current step produced by turning all transducers on and off at the same time. This reduced current step may reduce component stress caused by rapid changes in current inside the power supply, such as capacitors and rectifiers, due to powering up and down the bank of nebulizers. The power supply, typically a switching regulator type of power supply, thus may not have to respond to quick changes due to impulse current, but instead only relatively slow changes in energy demand as the on and off times of the nebulizers are typically in the order of about 0.1 seconds to about 10 seconds. Thus, the life of the power supply may be prolonged even when all of the nebulizers are commanded on at the same time.

Additionally, capacity control can be achieved reducing the number of nebulizers that are on at any given time. Using an example of a humidifier with four nebulizers, 25% output can be achieved by turning on one nebulizer and leaving it on; and 50% can be achieved with turning a second nebulizer leaving it on.

Capacity outputs between 25% and 50% can be accomplished by using PWM on one nebulizer while the other is left on. Even wear can be accomplished by turning off one nebulizer and turning on another.

Variations in the control of the PWM can be implemented in the humidifier controller without modifying the individual nebulizer by communicating to the nebulizer when to start, how long the period is, and the width of the duty cycle.

By way of example, a method of determining the percentage output of each nebulizer will now be discussed.

Generally, the overall goal of a humidification system is to maintain the relative humidity of a conditioned space. It may be desirable to accomplish this with the least amount of energy possible being expended. Turning back to FIG. 3, a humidifier or humidifier system (the system 3000 shown by way of representation in FIG. 3) may receive inputs of the current relative humidity or dew point, and the desired relative humidity or dew point—e.g., from sensors 308 directly connected to the system 3000 or a controller 302 thereof, or through a communications port or the like. Additionally, the system 3000 may receive inputs designed to limit the production of moisture due to certain conditions such as preventing a dew point at a point elsewhere in an air circulation system from falling below a condensing condition, or to prevent the generation of moisture when a circulating fan is not operating.

A nebulizer 300 may be most efficient in the use of power if it is on 100% of the time. A nebulizer 300 may have a minimum start-up time from the application of voltage to the oscillator circuit until the time droplets are being formed. During this start-up time, power may be consumed with no benefit of the production of water droplets. In traditional humidifiers, where all nebulizers are turned on and off together in a PWM fashion (to have the period set so that at, e.g., a 10% on time), the nebulizers generally have been on long enough to produce droplets. By way of example, a practical minimum on time would be twice the time it takes from the application of power to the formation of droplets. However, with the introduction of individual control of each nebulizer 300 in a humidifier of, e.g., ten or more nebulizers 300, the nebulizers 300 can be individually be turned off as the humidity rises to the set point with the last nebulizer 300 being operated at 10%. In the case of a humidifier with ten nebulizers 300, this can achieve the control of the humidity to be within 1% of the total capacity, rather than 10%.

With the individual control of the nebulizers 300, staging of the nebulizers 300 may be possible, with some nebulizers 300 being left to run at 100% output as the demand for humidification increases or decreases, thus allowing those nebulizers 300 to operate at their most efficient mode, eliminating the loss of efficiency due to the startup and shut down timing. The step-in supply current may be limited to what one nebulizer 300 uses, rather than the sum of all nebulizers 300.

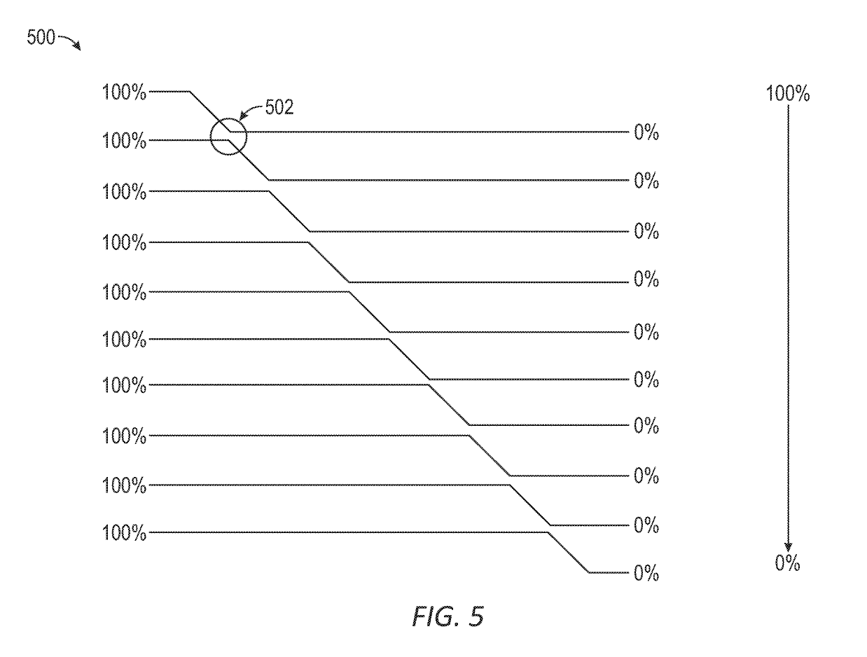

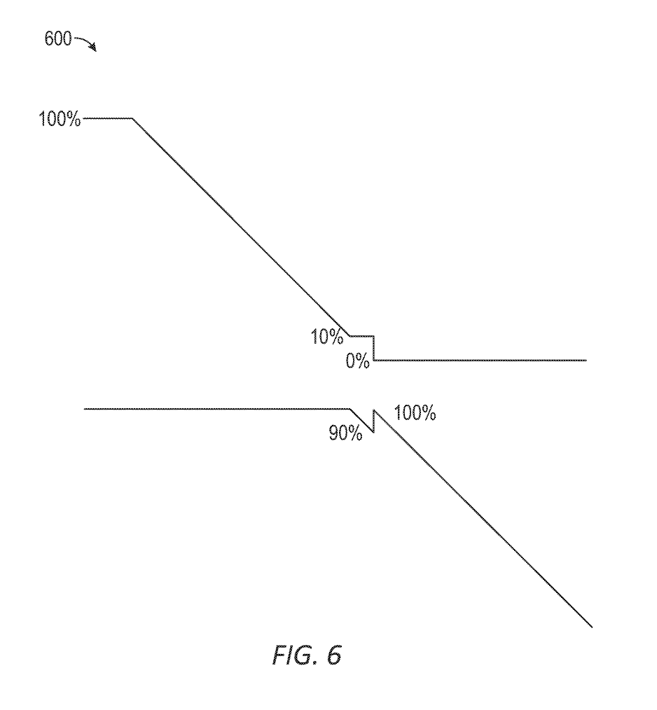

FIG. 5 illustrates a PWM scheme 500 for ultrasonic nebulizers, in accordance with a representative embodiment. Specifically, the PWM scheme 500 shown in FIG. 5 demonstrates an example of the PWM percentage set to the nebulizers in a humidifier with ten nebulizers as the humidity rises to the set point. In other words, the figure shows an example of the PWM command to each nebulizer as the set point is approached. A transition 502 is shown in more detail in FIG. 6.

FIG. 6 illustrates a transition 600 of output for ultrasonic nebulizers, in accordance with a representative embodiment. Specifically, the transition 600 may be the same or similar to the transition 502 shown in FIG. 5, but shown in more detail. Specifically, the example in FIG. 6 demonstrates the smooth transition at the minimum 10% output of one nebulizer to modulating the next nebulizer in a decreasing demand situation. A similar transition may be made during an increase of demand as the next nebulizer is turned on to its minimum pulse width.

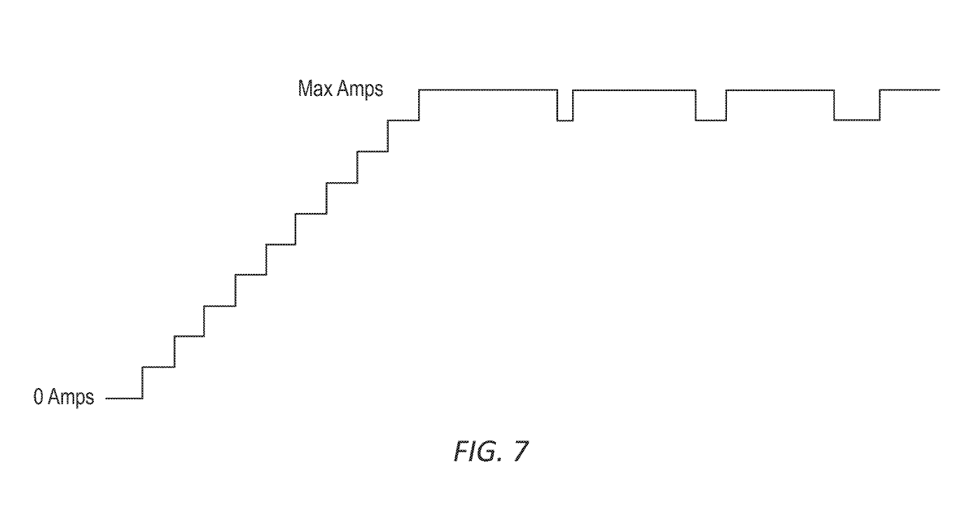

Furthermore, rotation of which nebulizers are on at 100% and which nebulizers are operated at a reduced duty cycle to achieve a desired percentage output may allow an even wear on transducers that do have a finite life time. This can be based on hours of operation or rotating when demand reaches 0% or 100%. FIG. 7 illustrates current demand on power for ultrasonic nebulizers, in accordance with a representative embodiment. Specifically, FIG. 7 shows an example of current demand on power up to 100%, then modulating one nebulizer. As shown in the figure, steps up to maximum amps may be spaced to be at least two times the turn-on time of the nebulizer.

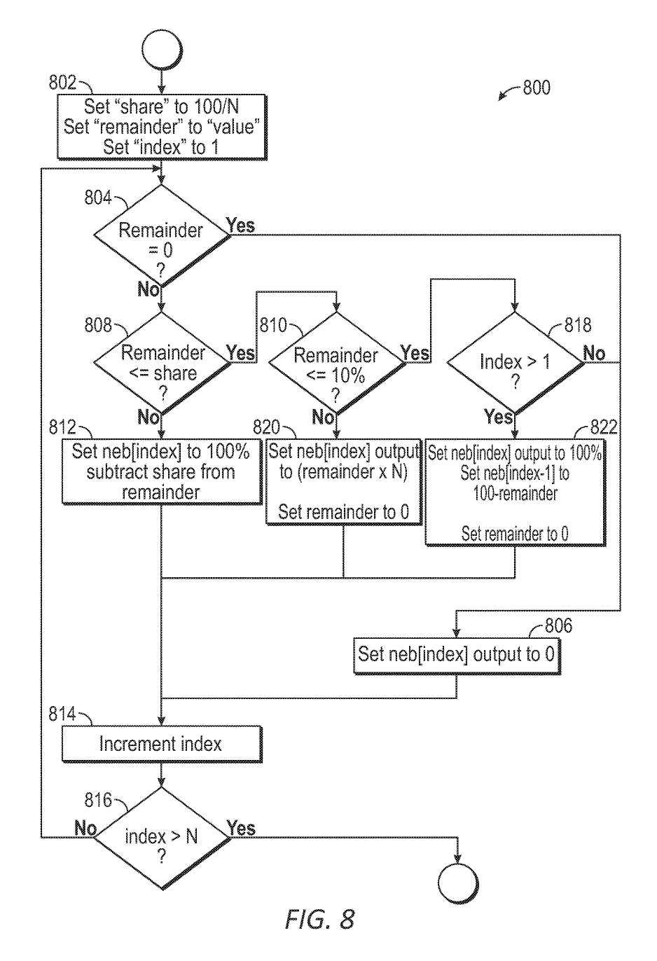

FIG. 8 illustrates a flow chart of a method 800 for determining the percent output for ultrasonic nebulizers, in accordance with a representative embodiment. In FIG. 8, “N” within the blocks represents the number of nebulizers in a humidifier, and “value” represents the percentage output of the humidifier.

As shown in block 802, the method 800 may include setting the “share” to 100/N setting the “remainder” to “value,” and setting “index” to 1. As shown in block 804, if the remainder is zero, then the method 800 may proceed to block 806, where the nebulizer index (i.e., “neb[index]”) output is set to zero. If the remainder is not zero, then the method 800 may proceed to block 808, where it may be determined whether the remainder is less than or equal to the share. If the remainder is less than or equal to the share, then the method 800 may proceed to block 810, where it may be determined whether the remainder is less than or equal to 10%. If the remainder is not less than or equal to the share, then the method 800 may proceed to block 812, where the nebulizer index (i.e., “neb[index]”) is set to 100% and the share is subtracted from the remainder. The method 800 may then proceed to block 814, where the index is incremented. As shown in block 816, if the index is greater than N, the method 800 may end, but if the index is not greater than N, the method 800 may proceed back to block 804.

Turning back to block 810, if the remainder is less than or equal to 10%, then the method 800 may proceed to block 818, where it may be determined whether the index is greater than 1. If the remainder is not less than or equal to 10%, then the method 800 may proceed to block 820, where the nebulizer index (i.e., “neb[index]”) output is set to (remainder×N) and the remainder is set to zero. As shown in block 818, if the index is greater than 1, the method 800 may proceed to block 822, where the nebulizer index (i.e., “neb[index]”) output is set to 100%, the nebulizer index (i.e., “neb[index]”) is set to (100−remainder), and the remainder is set to zero. If the index is not greater than 1, the method 800 may proceed back to block 804.

An example of communications between the humidifier controller and the nebulizers in the humidifier will now be discussed. No preset of addresses in the nebulizers may be required prior to startup of the humidifier, where all nebulizer boards may be programmed to a value deemed to be “no address assigned.”

Each nebulizer may have two serial ports, where one is connected to the previous nebulizer and the other to the next nebulizer—i.e., where nebulizer n is connected to nebulizer n−1 and nebulizer n+1. Nebulizer 0 may be the humidifier controller and nebulizer N, where N is the number of nebulizers, has no connection on the next nebulizer serial port. Commands from the humidifier controller may include messages in the form of packets that write data to a nebulizer or where the nebulizer sends back data. The packet may include a header to signal the start of a command, the address of the nebulizer to receive the command, the command itself, and, if it is a write command, the data being written to the nebulizer.

The nebulizers may not use a crystal for the microprocessor clock, where instead, the clock may be generated by an internal oscillator that has been trimmed to be as close to the advertised frequency as possible. The header part of the packet may contain a unique series of ones and zeros that are used by the receiving microcontroller to determine the bit timing for the rest of the packet, and if there is a response message, the same bit timing may be used. With this recalibrating of the timing of a one or a zero on every packet received, variations of clock frequency due to variables such as changing temperature of the microprocessor may be compensated in real time or near real time.

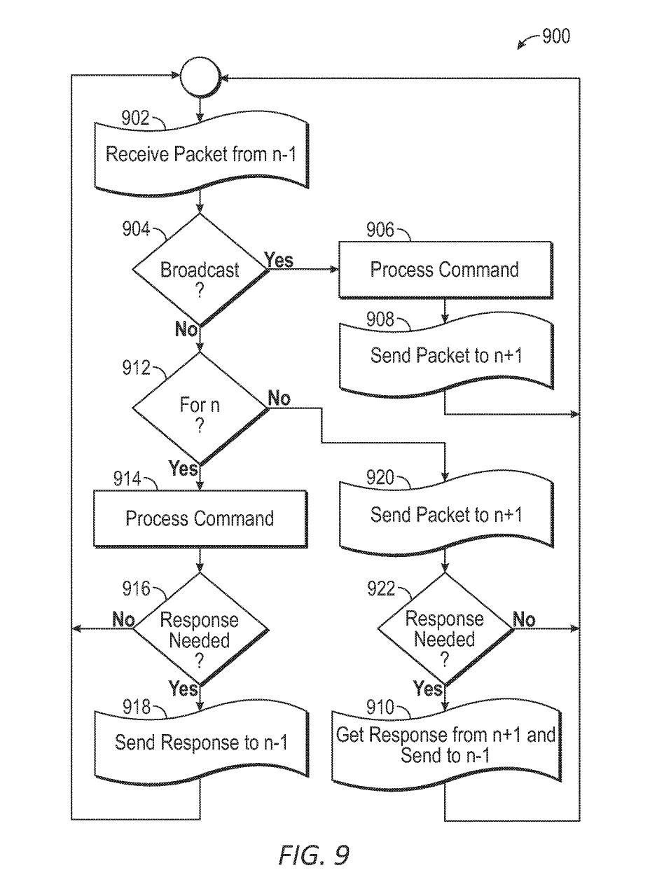

A packet may be received by a nebulizer from nebulizer n−1. If the address in the packet matches the nebulizer's address, the nebulizer processes the command. If it is a read command, the nebulizer sends a packet back to nebulizer n−1 with the data. If the address is greater than n, the nebulizer sends the packet to nebulizer n+1. If the packet is a read command and was passed to nebulizer n+1, the nebulizer n waits for a packet from nebulizer n+1 and then copies it to nebulizer n−1. FIG. 9 illustrates one method of managing packets.

Specifically, FIG. 9 illustrates a method 900 of managing packets for ultrasonic nebulizers, in accordance with a representative embodiment. In FIG. 9, ‘n’ is the nebulizer address. As shown in block 902, the method 900 may include receiving a packet from nebulizer n−1. As shown in block 904, if the packet is broadcast, the method 900 may proceed to block 906 where the command is processed. As shown in block 908, the method 900 may include sending the packet to nebulizer n+1. As shown in block 910, the method 900 may include obtaining a response from nebulizer n+1, and sending the response to nebulizer n−1.

If the packet is not broadcast, the method 900 may proceed to block 912 where it is determined whether the packet was for n. If the packet was for n, the method 900 may proceed to block 914, where the command is processed. As shown in block 916, if a response is needed, then the response is sent to nebulizer n−1 as per block 918. If a response is not needed, the method 900 may revert back to block 902.

If the packet was not for n, the method 900 may proceed to block 920, where the packet is sent to n+1. As shown in block 922, if a response is needed, then the response is obtained from n+1 and sent to nebulizer n−1 as per block 910. If a response is not needed, the method 900 may revert back to block 902.

An example discovery process will now be discussed. When a humidifier is powered up for the first time or when a nebulizer is replaced, a discovery process may be initiated via one of the external communications ports to the humidifier. The discovery process may include sending a broadcast packet with a universal address and a command to set the address of all nebulizers to “no address assigned.” Then, a packet may be sent with an address of 1 plus a command to set the nebulizer address. The first nebulizer may receive the packet, and because its address is “no address,” it may set its address to 1 in non-volatile memory where it does not pass the packet to the next nebulizer. The humidifier controller may then issue a packet to address 1 with a command to send back data. The first nebulizer recognizes the packet as being for itself and responds with the data. This may ensure the humidifier controller has successfully addressed the first nebulizer. The humidifier controller may send a packet with an address of 2 plus a command to set the nebulizer address. The first nebulizer receives the packet, and because its address is already set, assumes that it is for a nebulizer further down the line and passes the packet to the next nebulizer. The humidifier controller then issues a packet to address 2 with a command to send back data. The first nebulizer recognizes the packet as being beyond its address, passes it to the next nebulizer and waits for the response from the next nebulizer. The second nebulizer receives the first packet sent to it, and because its address is “no address,” sets its address to 2 in non-volatile memory and does not pass the packet to the next nebulizer. The second nebulizer then recognizes the read data packet as being for itself because its address matches and responds with the data. The process may be repeated for the remaining nebulizers, e.g., 3 and up. The humidifier controller can determine the number of nebulizers by the responses received and that can be compared to the number of nebulizers expected for fault analysis.

Once the addresses of all of the nebulizers are set, the discovery process may not need to take place. Upon application of power, each nebulizer may retrieve its address from its non-volatile memory so it is ready to process packets.

Commands can include, but are not restricted to, one or more of the following: writing the period for the PWM output; writing the percentage the nebulizer is on during that period; writing the temperature alarm point for the purpose of the nebulizer to locally shut down if the temperature rises above the temperature alarm point; reading the temperature of the nebulizer; and writing a correction factor to the temperature sensor.

Various nebulizer functions will now be discussed by way of example.

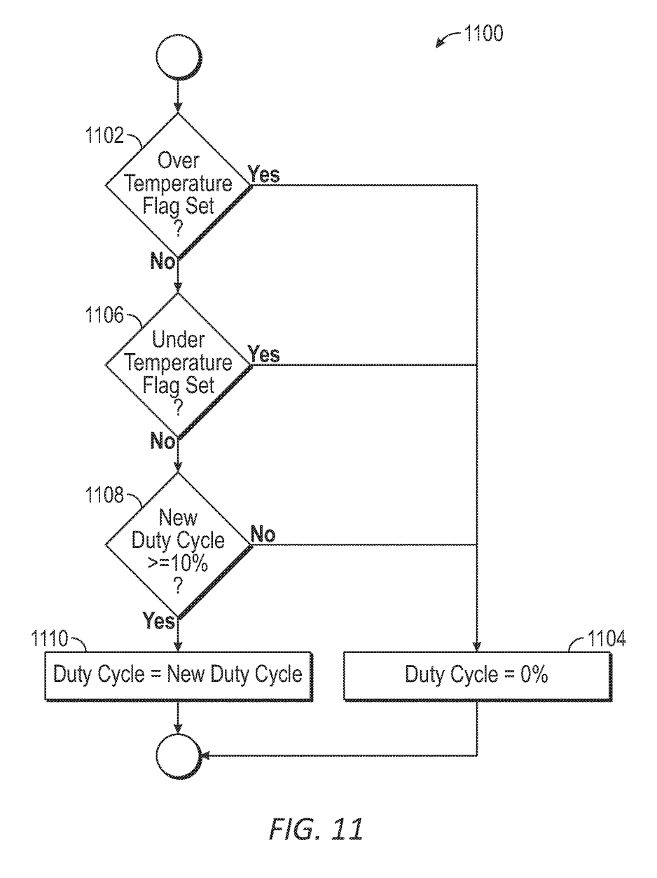

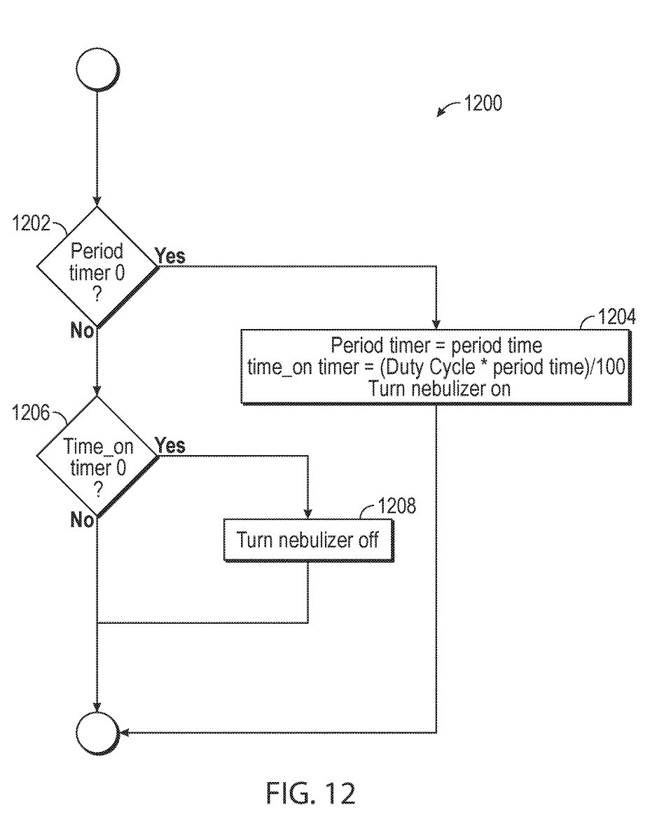

One of a nebulizer's main functions may be to turn the transducer on and off based on the commands received for the PWM period and the percentage of time it is to be on. If a nebulizer is commanded to run at less than 100%, the PWM period may be used to space the times the transducer is turned on. The transducer may be turned off after it has been on for a time substantially equal to the (PWM period×100)/percentage. For example, the flow chart in FIG. 11, discussed below, illustrates an example of a periodic, non-time critical process of determining the PWM duty cycle, and the flow chart in FIG. 12, discussed below, illustrates an example of PWM timing run by the controller's time-based interrupt service routine.

One of a nebulizer's secondary functions may be to monitor the temperature of the nebulizer to ensure the humidifier does not exceed temperatures at which the transducer and the power transistor driving the transducer can operate. The temperature of the heat sink may be used, along with the thermal conductivity of the thermal interface between the heat sink, the tank, and the water, as well as the thermal conductivity of the thermal interface between the heat sink and the power transistor. When the temperature rises above a preset value, the nebulizer may cease turning on, and the nebulizer may set an alarm flag in its status for the humidifier controller to examine. Once the temperature falls below a second preset value, normal operations may resume.

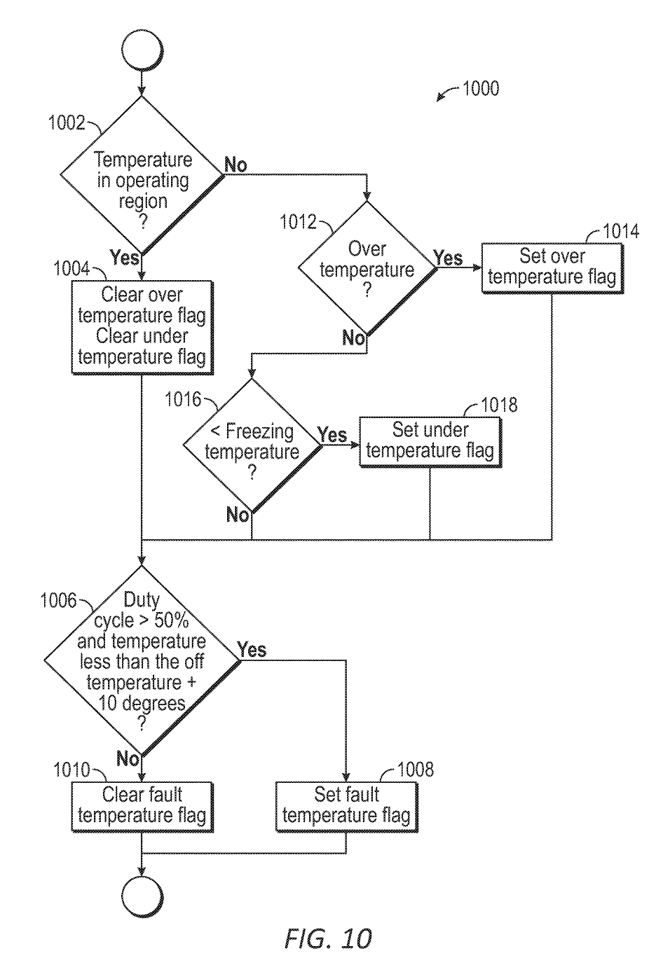

Under temperature can also or instead be monitored in a similar manner to prevent operations, e.g., when the water temperature is such that there is a danger of freezing conditions. Lack of proper operations can also or instead be determined from temperature rise. The power transistor may dissipate heat while the oscillator is running. Lack of a temperature rise when the transducer percentage is commanded to be above a predetermined amount, and when a reasonable time has passed with no temperature rise, may provide a fault condition to be determined and relayed back to the humidifier controller to alert the controller that a nebulizer is not operating correctly. The flow chart in FIG. 10 illustrates an example of three temperature checks, which may be executed on a periodic basis or otherwise.

Specifically, FIG. 10 illustrates a flow chart of a method 1000 for temperature checks for a humidifier, in accordance with a representative embodiment. As shown by block 1002, the method 1000 may include determining whether the temperature is in an operating region, e.g., a predetermined or preset operating region. As shown by block 1004, the method 1000 may include, when the temperature is in the operating region, clearing one or more of the over-temperature flag or the under-temperature flag. The method 1000 may then proceed to block 1006, where it is determined whether the duty cycle is greater than 50% (or another predetermined percentage), and whether the temperature is less than the off temperature plus 10 degrees (or another predetermined temperature). If the duty cycle is greater than 50% (or another predetermined percentage), and the temperature is less than the off temperature plus 10 degrees (or another predetermined temperature), then the method 1000 may proceed to block 1008, where the fault temperature flag is set. If one or more of the duty cycle is not greater than 50% (or another predetermined percentage), and/or the temperature is not less than the off temperature plus 10 degrees (or another predetermined temperature), then the method 1000 may proceed to block 1010, where the fault temperature flag is cleared. Thus, a purpose of the method 1000 may be to determine if the nebulizer is actually working, e.g., by observing the temperature. For example, if the oscillator is functioning, heat will be produced and a rise in temperature will be observed. And if there is an insignificant temperature rise, then the nebulizing action is most likely not occurring.

Turning back to block 1002, if the temperature is not in an operating region, then the method 1000 may proceed to block 1012, where it is determined whether there is an over-temperature condition. If so, then the over-temperature flag may be set as shown in block 1014, and the method 1000 may then proceed to block 1006 described above. If it is determined that there is not an over-temperature condition, then the method 1000 may proceed to block 1016, where it is determined whether the temperature is less than a freezing temperature (or another predetermined temperature of interest). If so, then the under-temperature flag may be set as shown in block 1018, and the method 1000 may proceed to block 1006 described above; if not, the method 1000 may proceed directly to block 1006 described above.

FIG. 11 illustrates a flow chart of a method 1100 for determining a PWM duty cycle for ultrasonic nebulizers, in accordance with a representative embodiment. As shown in block 1102, the method 1100 may include determining whether the over temperature is set. If the over temperature is set, the method 1100 may proceed to block 1104, where the duty cycle is set to zero percent. If the over temperature is not set, the method 1100 may proceed to block 1106, where it is determined whether the under-temperature flag is set. If the under temperature is set, the method 1100 may proceed to block 1104, where the duty cycle is set to zero percent. If the under temperature is not set, the method 1100 may proceed to block 1108, where it is determined whether the new duty cycle is greater than or equal to ten percent (or another predetermined percentage). If the new duty cycle is greater than or equal to ten percent (or another predetermined percentage), the method 1100 may proceed to block 1110, where the duty cycle is set to a new duty cycle. If the new duty cycle is not greater than or equal to ten percent (or another predetermined percentage), the method 1100 may proceed to block 1104, where the duty cycle is set to zero percent.

FIG. 12 illustrates a flow chart of a method 1200 for PWM timing for ultrasonic nebulizers, in accordance with a representative embodiment. FIG. 12 may include a PWM scheme for control of a nebulizer oscillator, where the duty cycle is from the method 1100 of FIG. 11, for example. The period and time-on timers may be interrupt driven and decremented to zero at a fixed frequency. Also, the period time may be set by a command from the humidifier controller.

As shown in block 1202, the method 1200 may include determining whether the period timer is zero. If so, the method 1200 may proceed to block 1204, where the period timer is set to the period time, the time-on timer is set to (the duty cycle×the period time)/100, and the nebulizer is turned on. If the period timer is not zero, the method 1200 may proceed to block 1206, where it is determined whether the time-on timer is zero. If so, the method 1200 may proceed to block 1208, where the nebulizer is turned off. If the time-on timer is not zero, the method 1200 may end.

Regarding humidifier control, in order to determine the percentage output that the transducers should produce, the humidifier controller may derive the information from local sensors or commands from communications ports including without limitation one or more of ModBus, USB, and ethernet ports, allowing higher-level systems to coordinate multiple humidifiers in the same conditioned space. By way of example, using ethernet ports, such as an ethernet interface to the humidifier controller, may be useful for the Internet of Things (IOT), and can allow up to and beyond 250 humidifiers to be connected to a system controller.

Although there are several methods of implementing the network, the public domain Local Interconnect Network (LIN) protocol developed for the automotive industry may be used. This protocol may allow for use of a single wire for communications. Along with power and ground for the microcontroller, the protocol may allow the use of a three-wire cable connecting all nebulizers in the humidifier to a controller that manages all aspects of the humidifier operation. This protocol may be self-synchronizing, eliminating the need for crystal controlled clocks in the nebulizers. The microcontroller may have the ability to store a trim value for the internal clock allowing even more precise control over the network timing.

An implementation may include an ultrasonic wave nebulizer including a piezo-electric transducer, and an electric circuit for electrically oscillating the transducer with a natural frequency thereof, controlled by a microprocessor embedded into the electric circuit.

An implementation may include a nebulizer electric circuit where the embedded microprocessor connects to a network of a master controller and other nebulizer electric circuits.

An implementation may include a nebulizer electric circuit where the embedded microprocessor retains a network address in its flash memory to uniquely identify it in the network.

An implementation may include a nebulizer electric circuit where the embedded microprocessor receives commands to locally control a PWM scheme turning on the piezo-electric transducer for a given amount of time within a programmable time window, thereby controlling the average vapor generated by the piezo-electric transducer.

An implementation may include a nebulizer electric circuit where the embedded microprocessor controls the starting point of the time window with respect to other ultrasonic wave nebulizers on the network.

An implementation may include a nebulizer electric circuit where the embedded microprocessor monitors the temperature of the drive transistor or transistors with heat sinks to the tank of the ultrasonic humidifier, and may thus be able to prevent damage or failure to the drive transistor and piezoelectric transducer.

An implementation may include a nebulizer electric circuit where the embedded microprocessor communicates to the network the current temperature and the status of the ultrasonic wave nebulizer.

An implementation may include a nebulizer electric circuit that reduces step loads to the power supply, which can improve the reliability of the power supply by reducing transient currents.

An implementation may include a nebulizer electric circuit where the reduction of transient currents may reduce the electromagnetic field generated during the steps in power and thus may reduce electromagnetic interference.

An implementation may include a nebulizer electric circuit where the network of ultrasonic wave nebulizers can be controlled individually to bring on more or remove ultrasonic wave nebulizers in the same tank thereby providing fine control of the volume of vapor produced by the ultrasonic humidifier.

Implementations may differ from other systems that detect that the oscillator is not operational by the opening of a fuse—such as U.S. Pat. No. 5,563,811, which is incorporated herein by reference in its entirety. Instead, implementations may include a circuit that measures the temperature of the transistor. For example, too high of a temperature may be an indication of a fault and the oscillator may be shut down to prevent overcurrent, and no temperature rise may be an indication that the oscillator is not functioning. Both conditions may be communicated over a serial bus or the like.

FIG. 13 illustrates a system 1300 for humidification, in accordance with a representative embodiment. As shown in the figure, the system 1300 may include a humidifier 1301, a controller 1330, a power source 1340, a computing device 1360, and one or more other resources 1370 all connected via a data network 1302 or otherwise in communication with one another in the system 1300.

The humidifier 1301 may include a nebulizer bank 1310, a water supply 1320, and one or more sensors 1350. The humidifier 1301 may be the same or similar to any of those described herein.

The nebulizer bank 1310 may include a plurality of ultrasonic nebulizers 1312. Although only three ultrasonic nebulizers 1312 are shown in the figure, it will be understood that many more ultrasonic nebulizers 1312 may be included in embodiments, e.g., the nebulizer bank 1310 may include at least 64 ultrasonic nebulizers 1312, or another number of ultrasonic nebulizers 1312. Each of the plurality of ultrasonic nebulizers 1312 may be in fluid communication with the water supply 1320, e.g., individually, in series, or in combined groups. In general, each of the plurality of ultrasonic nebulizers 1312 may be structurally configured for breaking up water in liquid form from the water supply 1320 into aerosol droplets for humidifying a volume.

The water supply 1320 may include a water tank disposed within the humidifier 1301. Such a water tank may be used as a heat sink for a power transistor 1336 of the controller 1330, microprocessor 1318, or another component of the system 1300 or humidifier 1301. The water supply 1320 may also or instead include a connection to a pipe that feeds water from a water source 1322. It will be understood that, in certain implementations, the water supply 1320 may include another liquid or substance in addition to, or instead of, water.

The controller 1330 may include, or may otherwise be in communication with, a processor 1332 and a memory 1334. The controller 1330 may be electronically coupled (e.g., wired or wirelessly) in a communicating relationship with one or more of the components of the system 1300 for controlling those components, e.g., through the data network 1302, or the components and the controller 1330 may be otherwise communicatively coupled. Also, or instead, components may include their own integrated controller(s) 1330.

The controller 1330 may be in communication with each of the plurality of ultrasonic nebulizers 1312 to selectively activate each of the plurality of ultrasonic nebulizers 1312 independently from one another, or in set groups depending on the control scheme and other parameters, e.g., information from one or more sensors 1350. In implementations, the controller 1330 may be configured to stage activation of one or more of the plurality of ultrasonic nebulizers 1312 while accounting for at least one of: (i) a time from startup to a production of an aerosol droplet for each ultrasonic nebulizer 1312; (ii) a threshold power consumption for the humidifier 1301; (iii) a temperature of a component of the humidifier 1301 or system 1300; and (iv) a predetermined humidity of the volume to be humidified/conditioned.

In implementations, the controller 1330 may be configured to activate each of the plurality of ultrasonic nebulizers 1312 according to a PWM scheme. Also, or instead, the controller 1330 may be configured to activate each of the plurality of ultrasonic nebulizers 1312 according to a predetermined period and duty cycle. The predetermined period and duty cycle may be selected to maintain a predetermined humidity or dew point in the volume to be humidified/conditioned.

In certain implementations, power 1342 may be constantly supplied to each of the plurality of ultrasonic nebulizers 1312, and the controller 1330 may communicate with a microprocessor 1318 or the like in each ultrasonic nebulizer 1312 (or in communication with each ultrasonic nebulizer 1312) to determine whether to turn the ultrasonic nebulizer 1318 on or off, or otherwise to set the output of the ultrasonic nebulizer 1312. In other implementations, the controller 1330 is in communication with each of the plurality of ultrasonic nebulizers 1312 to control power 1342 that is supplied to each of the plurality of ultrasonic nebulizers 1312 independently from one another.

In general, the controller 1330 may be electrically coupled in a communicating relationship, e.g., an electronic communication, with any of the components of the system 1300. In general, the controller 1330 may be operable to control the components of the system 1300 or humidifier 1301, such as the ultrasonic nebulizers 1312 and the power source 1340 or switching regulator 1344. The controller 1330 may include any combination of software and/or processing circuitry suitable for controlling the various components of the system 1300 described herein including without limitation processors, microprocessors 1318, microcontrollers, application-specific integrated circuits, programmable gate arrays, and any other digital and/or analog components, as well as combinations of the foregoing, along with inputs and outputs for transceiving control signals, power signals, sensor signals, and the like. In certain implementations, the controller 1330 may include the processor 1332 or other processing circuitry with sufficient computational power to provide related functions such as executing an operating system, providing a graphical user interface (e.g., to a display coupled to the controller 1330 or another component of the system 1300), set and provide rules and instructions for operation of the humidifier 1301, ultrasonic nebulizers 1312, or another component of the system 1300, convert sensed information or input information into instructions, and operate a web server or otherwise host remote operators and/or activity through a communications interface 1304. In certain implementations, the controller 1330 or microprocessor 1318 may include a printed circuit board, an Arduino controller or similar, a Raspberry Pi controller or the like, a prototyping board, or other computer related components.

The controller 1330 may be a local controller disposed on the humidifier 1301, or a remote controller 1330 otherwise in communication with the humidifier 1301 and its components. For example, the controller 1330 may be disposed on an external component (e.g., the computing device 1360) in communication with the humidifier 1301 over a data network 1302.

The processor 1332 (of the controller 1330 or in communication therewith) may include an onboard processor for the humidifier 1301. The processor 1332 may also or instead be disposed on a separate computing device 1360 that is connected to the humidifier 1301 through a data network 1302, e.g., using the communications interface 1304, which may include a Wi-Fi transmitter and receiver. The processor 1332 may perform calculations for operating components of the system 1300 such as the humidifier 1301.

The processor 1332 may be any as described herein or otherwise known in the art. The processor 1332 may be included on the controller 1330, or it may be separate from the controller 1330, e.g., it may be included on a computing device 1360 in communication with the controller 1330 or another component of the system 1300. In an implementation, the processor 1332 is included on, or in communication with, a server that hosts an application for operating and controlling the system 1300.

The memory 1334 may be any as described herein or otherwise known in the art. The memory 1334 may contain computer code and may store data such as sequences of activation or power supply for the humidifier 1301 and its components. The memory 1334 may contain computer executable code stored thereon that provides instructions for the processor 1332 for implementation. The memory 1334 may include a non-transitory computer readable medium. The memory 1334 may be included on a removable memory device such as a USB drive, memory stick, or the like, which may be used for example to transfer data between components of the system 1300. The memory 1334 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 1334 may store program instructions, program data, executables, and other software and data useful for controlling operation of the components of the system 1300 and configuring the components of the system 1300 to perform functions for a user. The memory 1334 may, in general, include a non-volatile computer readable medium containing computer code that, when executed by components of the system 1300 creates an execution environment for a computer program in question, e.g., code that constitutes processor firmware, a protocol stack, a database management system, an operating system, or a combination of the foregoing, and/or code that performs some or all of the operations set forth in the various flow charts and other algorithmic descriptions set forth herein. While a single memory 1334 is depicted, it will be understood that any number of memories may be usefully incorporated into components of the system 1300. The processor 1332 and the memory 1334 can be supplemented by, or incorporated in, logic circuitry.

The system 1300 may include one or more sensors 1350. The one or more sensors 1350 may include a thermal sensor in communication with the controller 1330 to prevent overheating of the plurality of ultrasonic nebulizers 1312. The one or more sensors 1350 may also or instead include a humidity sensor, other temperature sensor, water level sensors, or various sensors known in the art.

Power 1342 may be supplied to one or more components of the system 1300 (e.g., the plurality of ultrasonic nebulizers 1312) through a switching regulator 1344 or the like, which may be in communication with the power source 1340. The power source 1340 may be any known in the art or that will become known in the art. For example, power sources 1340 may include an AC to DC converter (e.g., grid power), solar power, battery power, wind power, fossil fuel sourced power, and so on.

Each of the plurality of ultrasonic nebulizers 1312 may include a piezo-electric transducer 1314 (or other transducer or the like) and an electric circuit 1316 for electrically oscillating the piezo-electric transducer 1314 with a natural frequency thereof. The system 1300 may further include a microprocessor 1318 embedded into the electric circuit 1316 for controlling the piezo-electric transducer 1314. The microprocessor 1318 may be in communication with the controller 1330 and other nebulizer electric circuits 1316. The microprocessor 1318 may retain a network address in its flash memory to uniquely identify itself in a network, e.g., the data network 1302 or a network of ultrasonic nebulizers 1312. For example, the microprocessor 1318 may recognize the ultrasonic nebulizer 1312 to which its associated, as well as neighboring ultrasonic nebulizers 1312. The microprocessor 1318 may receive commands to locally control a PWM scheme turning on the piezo-electric transducer 1314 for a given amount of time within a programmable time window, thereby controlling aerosol droplets generated by the piezo-electric transducer 1314. The microprocessor 1318 may control a starting point of a time window with respect to other ultrasonic nebulizers 1312 on a network, e.g., the data network 1302 or a network of ultrasonic nebulizers 1312. The microprocessor 1318 may monitor a temperature of one or more drive transistors 1336 with heat sinks to the water supply 1320, where the microprocessor 1318 is configured to prevent damage or failure to the one or more drive transistors 1336 and the piezo-electric transducer 1314. The microprocessor 1318 may communicate a current temperature and a status of one or more of the plurality of ultrasonic nebulizers 1312 to the controller 1330 through the data network 1302.

The data network 1302 may be any network(s) or internetwork(s) suitable for communicating data and control information among participants and components in the system 1300. This may include public networks such as the internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m) and/or other technologies, as well as any of a variety of corporate area or local area networks and other switches, routers, hubs, gateways, and the like that might be used to carry data among participants in the system 1300. The data network 1302 may include wired or wireless networks, or any combination thereof. One skilled in the art will also recognize that the participants shown the system 1300 need not be connected by a data network 1302, and thus can be configured to work in conjunction with other participants independent of the data network 1302.

Communication over the data network 1302, or other communication between components of the devices or systems described herein, may be provided via one or more communications interfaces 1304. The communications interface 1304 may include, e.g., a Wi-Fi receiver and transmitter to allow the logic calculations to be performed on a separate computing device 1360, rather than on specific components of the system 1300. This may include connections to smartphone applications and the like. More generally, the communications interface 1304 may be suited such that any of the components of the system 1300 can communicate with one another. Thus, the communications interface 1304 may be present on one or more of the components of the system 1300. The communications interface 1304 may include, or be connected in a communicating relationship with, a network interface or the like. The communications interface 1304 may include any combination of hardware and software suitable for coupling the components of the system 1300 to a remote device (e.g., a computing device 1360 such as a remote computer or the like) in a communicating relationship through a data network 1302. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple into a local area network or the like that is in turn coupled to a data network such as the internet. This may also or instead include hardware/software for a WiMAX connection or a cellular network connection (using, e.g., CDMA, GSM, LTE, or any other suitable protocol or combination of protocols). Additionally, the controller 1330 may be configured to control participation by the components of the system 1300 in any network to which the communications interface 1304 is connected, such as by autonomously connecting to the data network 1302 to retrieve status updates and the like.

The system 1300 may include one or more computing devices 1360, which are in communication with one or more of the components of the system 1300 including without limitation the controller 1330. The computing device 1360 may include a user interface, which may be used, e.g., to adjust the humidifier 1301. The user interface may include a graphical user interface, a text or command line interface, a voice-controlled interface, and/or a gesture-based interface. In general, the user interface may create a suitable display on the computing device 1360 for operator interaction. In implementations, the user interface may control operation of one or more of the components of the system 1300, as well as provide access to and communication with the controller 1330, processor 1332, and other resources 1370.

The computing device 1360 may include any devices within the system 1300 operated by operators or otherwise to manage, monitor, communicate with, or otherwise interact with other participants in the system 1300. This may include desktop computers, laptop computers, network computers, tablets, smartphones, smart watches, PDAs, or any other device that can participate in the system 1300 as contemplated herein. In an implementation, the computing device 1360 is integral with another participant in the system 1300.

The system 1300 may include other resources 1370. In certain implementations, the other resources 1370 may include sensors, cameras, power sources, gauges, and the like. The other resources 1370 may also or instead include input devices such as a keyboard, a touchpad, a computer mouse, a switch, a dial, a button, and the like, as well as output devices such as a display, a speaker or other audio transducer, light emitting diodes or other lighting or display components, and the like. Other resources 1370 of system 1300 may also or instead include a variety of cable connections and/or hardware adapters for connecting to, e.g., external computers, external hardware, external instrumentation or data acquisition systems, and the like.

The other resources 1370 may also or instead include a server, a database or other data storage, a remote resource, a network interface, processing circuitry, and the like. Thus, other resources 1370 such as other hardware or other software may be included in addition to, or instead of, components described above.

FIG. 14 illustrates a flow chart of a method 1400 for humidification, in accordance with a representative embodiment. The method 1400 may be implemented by a computer program product comprising computer executable code embodied in a non-transitory computer readable medium that, when executing on one or more computing devices, performs the steps of the method 1400.

As shown in block 1402, the method 1400 may include selectively activating one or more ultrasonic nebulizers of a plurality of ultrasonic nebulizers included on a nebulizer bank of a humidifier, where each of the plurality of ultrasonic nebulizers is structurally configured for breaking up water in liquid form into aerosol droplets for humidifying a volume.

As shown in block 1404, the method 1400 may include staging activation of the one or more ultrasonic nebulizers while accounting for at least one of: (i) a time from startup to a production of an aerosol droplet for the one or more ultrasonic nebulizers; (ii) a threshold power consumption for the humidifier; (iii) a temperature of a component of the humidifier; and (iv) a predetermined humidity of the volume.

As shown in block 1406, the method 1400 may include supplying power to the one or more ultrasonic nebulizers according to one or more of (i) a pulse width modulation (PWM) scheme, and (ii) a predetermined period and duty cycle.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another implementation, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another implementation, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another implementation, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of this disclosure and are intended to form a part of the disclosure as defined by the following claims, which are to be interpreted in the broadest sense allowable by law.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A humidifier, comprising:
a water supply;
a nebulizer bank comprising a plurality of ultrasonic nebulizers, each of the plurality of ultrasonic nebulizers in fluid communication with the water supply, and each of the plurality of ultrasonic nebulizers structurally configured for breaking up water in liquid form from the water supply into aerosol droplets for humidifying a volume; and
a controller comprising a processor and a memory, the controller in communication with each of the plurality of ultrasonic nebulizers to selectively activate each of the plurality of ultrasonic nebulizers independently from one another, and the controller configured to stage activation of one or more of the plurality of ultrasonic nebulizers while accounting for at least one of: (i) a time from startup to a production of an aerosol droplet for each ultrasonic nebulizer; (ii) a threshold power consumption for the humidifier; (iii) a temperature of a component of the humidifier; and (iv) a predetermined humidity of the volume.

2. The humidifier of claim 1, where the controller is configured to activate each of the plurality of ultrasonic nebulizers according to a pulse width modulation (PWM) scheme.

3. The humidifier of claim 1, where the controller is configured to activate each of the plurality of ultrasonic nebulizers according to a predetermined period and duty cycle.

4. The humidifier of claim 3, where the predetermined period and duty cycle is selected to maintain a predetermined humidity or dew point in the volume.

5. The humidifier of claim 1, further comprising a thermal sensor in communication with the controller to prevent overheating of the plurality of ultrasonic nebulizers.

6. The humidifier of claim 1, where power is supplied to the plurality of ultrasonic nebulizers through a switching regulator.

7. The humidifier of claim 1, where each of the plurality of ultrasonic nebulizers comprises a piezo-electric transducer and an electric circuit for electrically oscillating the piezo-electric transducer with a natural frequency thereof.

8. The humidifier of claim 7, further comprising a microprocessor embedded into the electric circuit for controlling the piezo-electric transducer.

9. The humidifier of claim 8, where the microprocessor is in communication with the controller and other nebulizer electric circuits.

10. The humidifier of claim 9, where the microprocessor retains a network address in its flash memory to uniquely identify itself in a network.

11. The humidifier of claim 9, where the microprocessor receives commands to locally control a pulse width modulation (PWM) scheme turning on the piezo-electric transducer for a given amount of time within a programmable time window, thereby controlling aerosol droplets generated by the piezo-electric transducer.

12. The humidifier of claim 9, where the microprocessor controls a starting point of a time window with respect to other ultrasonic nebulizers on a network.

13. The humidifier of claim 9, where the microprocessor monitors a temperature of one or more drive transistors with heat sinks to the water supply, and where the microprocessor is configured to prevent damage or failure to the one or more drive transistors and the piezo-electric transducer.

14. The humidifier of claim 9, where the microprocessor communicates a current temperature and a status of one or more of the plurality of ultrasonic nebulizers to the controller through a network.

15. The humidifier of claim 1, where the water supply is a water tank disposed within the humidifier.

16. The humidifier of claim 15, where the water tank is used as a heat sink for a power transistor of one or more components of the humidifier.

17. The humidifier of claim 1, where the water supply is a connection to a pipe feeding water from a water source.

18. The humidifier of claim 1, where the nebulizer bank comprises at least 64 ultrasonic nebulizers.

19. A computer program product comprising computer executable code embodied in a non-transitory computer readable medium that, when executing on one or more computing devices, performs the steps of:
selectively activating one or more ultrasonic nebulizers of a plurality of ultrasonic nebulizers included on a nebulizer bank of a humidifier, each of the plurality of ultrasonic nebulizers structurally configured for breaking up water in liquid form into aerosol droplets for humidifying a volume; and
staging activation of the one or more ultrasonic nebulizers while accounting for at least one of: (i) a time from startup to a production of an aerosol droplet for the one or more ultrasonic nebulizers; (ii) a threshold power consumption for the humidifier; (iii) a temperature of a component of the humidifier; and (iv) a predetermined humidity of the volume.

20. The computer program product of claim 19, further comprising computer executable code that performs the step of activating the one or more ultrasonic nebulizers according to one or more of (i) a pulse width modulation (PWM) scheme, and (ii) a predetermined period and duty cycle.
